(19) United States
(12) Patent Application Publication
(10) Pub. No.: US 2023/0188999 A1
(43) Pub. Date: Jun. 15, 2023

(54) METHOD AND DEVICE FOR DETECTING A SECURITY FLAW

(71) Applicant: Orange, Issy-les-Moulineaux (FR)

(72) Inventors: Eric Bouvet, CHATILLON (FR); Fabrice Fontaine, CHATILLON (FR)

(21) Appl. No.: 18/003,176

(22) PCT Filed: Jun. 14, 2021
(86) PCT No.: PCT/FR2021/051060

§ 371 Date: Dec. 23, 2022

(30) Foreign Application Priority Data
Jun. 26, 2020 (FR) 2006715

(51) Int. Cl. H04W 12/122; H04L 9/40

(52) U.S. Cl. CPC H04W 12/122; H04L 63/1425

(57) ABSTRACT

A method for detecting a security flaw allowing a sensitive datum to be recovered. The method is implemented by a device of a network-gateway type holding the sensitive datum. The sensitive datum allows a network terminal to connect to the device. The method includes: analyzing messages sent by at least a first terminal of the network administrated by the device, which terminal is referred to as a terminal known by the device, to another terminal; the device detecting the security flaw if it detects presence of the sensitive datum in the message.

### CROSS-REFERENCE TO RELATED APPLICATIONS

This Application is a Section 371 National Stage Application of International Application No. PCT/FR2021/051060, filed Jun. 14, 2021, which is incorporated herein by reference in its entirety and published as WO 2021260289 on Dec. 30, 2021, not in English.

### FIELD OF THE DISCLOSURE

The invention relates to the general field of telecommunications. It relates more particularly to the detection of a security breach which allows an unauthorized terminal to fraudulently obtain a sensitive datum.

By way of example, the sensitive datum may be a password for connecting to network termination equipment, this type of equipment being known in France under the name of ‘box’, such as the LiveBox (product marketed by Orange, trademark) offering multiple services. A terminal can connect to the network termination equipment using the password so as to be able to benefit from a service such as an Internet connection service.

### BACKGROUND OF THE DISCLOSURE

In order to avoid the password being disclosed in an unsecured manner, a solution is known which consists in allowing the terminals to only connect to the network termination equipment after a manual input of the password. However, this solution requires the user to input the password manually for each new terminal that he/she wishes to connect, which is tedious especially when the password is long.

A solution is known allowing the experience of the user to be improved, called WPS (for “Wi-Fi Protected Setup”), which consists in configuring the network termination equipment for it to accept all the terminal connection requests received during a certain interval of time without using a password, for example for two minutes starting from the pushing of a button activating the WPS functionality. This solution however presents a security breach: a malicious terminal can connect in place of the legitimate equipment when the WPS functionality is activated.

A solution is known which allows the secure communication of the password while at the same time improving the experience of the user. This solution consists in using a specific protocol on a terminal already paired with the network termination equipment, in order to automatically broadcast the password to the new terminals that wish to connect to the equipment. For example, the terminal already connected may send the password to a new terminal via a BLE (for “Bluetooth Low Energy”) network which will allow the new terminal to connect to a WiFi network covered by the network termination equipment. The user is not obliged to manually input the password for the new terminals, but only for the first terminal. Moreover, this solution is more secure than the WPS functionality because it requires the new terminal to firstly connect to the first terminal via the BLE network.

However, even the latter solution presents a security breach: a malicious terminal can intercept the BLE communications between the first terminal and the new terminal, and subsequently recover the password for the network termination equipment.

There is accordingly a need for a solution allowing a security breach that enables a malicious terminal to recover a sensitive datum, such as a password, to be detected.

### SUMMARY

The invention is aimed at a method for detecting a security breach allowing a sensitive datum to be recovered, the method being implemented by a device of the network gateway type holding the sensitive datum, said sensitive datum allowing a terminal of the network to connect to said device, said method comprising steps for:

analyzing messages sent by at least a first terminal of the network managed by the device, referred to as terminal known by the device, to another terminal;

the device detects a said security breach if it detects the presence of the sensitive datum in an analyzed message.

In a correlated manner, the invention is aimed at a device for detecting a security breach allowing a sensitive datum to be recovered, the device of the network gateway type holding the sensitive datum, said sensitive datum allowing a terminal of the network to connect to said device, and comprising:

an analysis module configured for analyzing the messages sent by at least a first terminal of the network managed by the device, referred to as terminal known by the device, to another terminal; and

a module for detecting breaches configured for detecting a security breach if it detects the presence of the sensitive datum in an analyzed message.

The features and advantages of the method for detecting a security breach according to the invention presented hereinafter are applicable in the same way to the detection device according to the invention and vice versa.

The first terminal is known by the detection device means that an identifier of the first terminal is recorded in a memory accessible by the device. The fact that the identifier is stored in memory allows the device to identify and monitor the messages notably transmitted by this first terminal.

In particular, the first terminal may be or have been connected and paired to the device. The first terminal may have been connected to the detection device under a control by a user of the device, for example following a manual input by the user of a connection password, or following an authentication of the first terminal by the detection device. If the first device is a network gateway, in this case the terminal forms a part of the network.

The first terminal may obtain the sensitive datum in an authorized manner.

The technique provided allows the security vulnerabilities and breaches to be detected on which a malicious terminal may rely for intercepting the messages between the first terminal and the other terminal and to obtain the sensitive datum. The technique provided therefore allows the security of the communications network comprising the detection device and the first terminal to be improved.

The detection device provided does not need to decipher the analyzed messages. If the first terminal communicates the sensitive datum to the other terminal in an encrypted manner, the detection device provided does not detect the cleartext sensitive datum in the analyzed messages and does not then detect any security breach.

The experience of a user of the detection device or of a user of the first terminal is not impacted by the implementation of the method according to the invention.

In one particular embodiment, the method provided furthermore comprises:

a step for monitoring destinations of the messages sent by the first terminal;

a step for detecting that the destination of a said message sent is a terminal not known by the device, referred to as “new terminal”;

the step for analyzing messages being implemented upon said detection and only for the messages sent to the new terminal.

According to this embodiment, the detection device provided furthermore comprises:

a monitoring module configured for monitoring the destinations of the messages sent by the first terminal; and

a module for detecting new terminals configured for detecting that the destination of a message sent is a terminal not known by the device, referred to as “new terminal”; the analysis module being configured for only analyzing the messages sent to the new terminal, upon said detection.

According to this embodiment, the device for detecting a security breach monitors the destinations of the messages sent by the first terminal so as to be able to determine whether a new terminal has just connected to the first terminal, but the detection device does not need to analyze the contents of the messages exchanged between the first terminals already known by the device. The device for detecting a security breach only analyzes the contents of the messages at the appropriate time, in other words upon detection of the communication between the new terminal and the first terminal.

The detection device provided may monitor and analyze communications of the first terminal which are based on different technologies, for example wired communications, WiFi (for “Wireless Fidelity”), Bluetooth, BLE, Thread, Zigbee (IEEE 802.15.4), Z-Wave, DECT (“Digital Enhanced Cordless Telecommunications”) and/or DECT ULE (for “DECT Ultra Low Energy”) communications.

The technology for connection of the first terminal to the detection device may be different from the technology for connection of the first terminal to the other terminal (the recipient of the message). For example, the connection between the first terminal and the detection device may be based on a network of the WiFi type, whereas the connection between the first and the other terminal is based on one of the protocols: Bluetooth, Thread, Zigbee, Z-Wave, DECT or DECT ULE. In particular, the connection between the terminals may be based on an unsecured mode of connection of the Bluetooth standard, for example the “BLE Just Works” mode.

In one particular embodiment, the monitoring step comprises a monitoring of the messages sent over all of the communications channels used by the first terminal, irrespective of the technology to which a channel conforms.

In one particular embodiment, the monitoring step comprises eavesdropping on channels of the “advertising” type according to the Bluetooth standard. Such an eavesdropping allows the sender and the receiver of a message to be known and thus it to be determined whether the message is transmitted to a new terminal.

The invention is also aimed at equipment comprising a device according to the invention such as previously described, in which the equipment is of the network termination type, an extender of coverage of a wireless communications network, a server for sensitive data, or user equipment.

In one particular embodiment, the detection device according to the invention is a gateway between a local-area network and a wide-area network such as the Internet. In particular, the detection device may be network termination equipment (a ‘box’). In this embodiment, the sensitive datum may be at least one password allowing a terminal of the local-area network to connect to the gateway and thus to connect to the wide-area network. Alternatively, the sensitive datum may be a health or identity document of a user.

In one particular embodiment, the detection device according to the invention is an extender of coverage of a wireless communications network, for example a WiFi extender or a DECT ULE extender. The sensitive datum is a password allowing a terminal to connect to the extender so as to benefit from the coverage of the wireless network.

In one particular embodiment, the detection device according to the invention is a server storing sensitive data comprising personal information of a user of the server, for example information on an identity document, for example a passport or other personal document, information on a means of payment such as a number or a code of a bank card, or information on a health document of the user.

In particular, the detection device may be user equipment such as a computer, a smartphone, or a tablet.

Other types of detection devices and of sensitive data may be envisioned. The examples of application of the method and of the device for detecting a security breach presented hereinabove are not limiting.

In one particular embodiment, the step for analyzing the messages sent by the first terminal is implemented for a given duration starting from the detection of the first message sent by the first terminal to the other terminal. According to this embodiment, the detection device considers that, upon expiration of this duration, the first terminal will not send the sensitive datum to the other terminal and hence that the risk of a security breach occurring is low. In particular, when the sensitive datum is a password for connecting to the device, it is common for the other terminal to request this password at the start of its communication with the first terminal.

In one particular embodiment, when the other terminal is a new terminal, the analysis step furthermore comprises the analysis of the contents of the messages sent by the new terminal to the first terminal. This embodiment allows the device provided to detect a request for sending the sensitive datum and thus to implement an anticipated countermeasure, even before the first terminal responds to the request and sends the sensitive datum.

In one embodiment, the device provided detects that the destination of a message sent is a terminal not known by the device (a new terminal) on the basis of the physical MAC (for “Media Access Control”) address of the new terminal or based on other information if the MAC address is random, for example on a frequency change algorithm used by the new terminal or on a strength of a signal sent out by the new terminal. In this embodiment, the detection device compares the characteristics of a terminal recipient of a message sent by the first terminal with the stored data; if this is not found in its memory, it determines that the terminal is a new terminal. In particular, the device may have access to a memory storing the MAC addresses, the frequency change algorithm and/or the signal strengths of the terminals known by the device.

In one embodiment, the method provided furthermore comprises a step for determining at least one characteristic of the other terminal, the step for analyzing the messages sent by the first terminal to the other terminal being conditioned by this characteristic. The characteristic may be a manufacturer of the other terminal, a unique identifier UUID (for «Universally Unique Identifier”) of a service used by the other terminal, and/or a prefix of a name of the other terminal.

In particular, the detection device provided may determine a manufacturer, a type or a model of the new terminal based on its physical MAC address. The device provided may obtain the MAC address from the monitored message. A UUID identifier may be determined from a field of a packet of the “Bluetooth advertising” type generated by the other terminal or from a signature generated by the other terminal over a given radio wave. The name or a prefix of the name of the other terminal may be determined from a Bluetooth identifier of the “org.bluetooth.characteristic.gap.device_name” type or from a number assigned according to the Bluetooth specification of the “0x2a00” type.

In one particular embodiment, the detection device according to the invention stores a list of manufacturers of terminals and only analyses the messages intended for a terminal if its manufacturer is included in this list or excluded from the latter.

A user of the detection device may then configure the device in order to indicate categories of trusted terminals, for example the terminals from a given manufacturer.

In one particular embodiment, the detection device according to the invention stores a list of prefixes of names of terminals and only analyses the messages intended for a terminal if its prefix is included in this list or excluded from the latter.

In one particular embodiment, the detection device according to the invention stores a list of UUID identifiers and only analyses the messages intended for a terminal if it supports a service whose UUID identifier is included in this list or excluded from the latter.

In one particular embodiment, if no security breach is detected for the analyzed messages intended for a new terminal, the detection device provided records an identifier of the new terminal in a memory comprising identifiers of terminals known by the device. The device does not reconsider this terminal as a new terminal if it detects later on one of its communications. This embodiment allows the analysis of the messages intended for terminals already known by the device and which are considered as trustworthy to be avoided.

In one embodiment, the detection device erases the identifier of a terminal from its memory if this terminal is unpaired from the detection device, or upon a configuration by the user of the device. This terminal could thus be considered later on as a new terminal. This embodiment allows the detection of the security breaches to be improved; indeed, this terminal may be involved in the future in a security breach.

In one embodiment, the detection device provided saves the messages sent by the first terminal to another terminal in order to analyze them at a later date and to verify if they are disclosing the sensitive datum. It is recalled that the device provided can recognize and detect the sensitive datum since it is holding it. In particular, these messages may be stored with a time-stamp in order for a user to potentially recover information on the dates of the presence of a security breach.

In another embodiment, the detection device verifies in real time whether the analyzed messages comprise the sensitive datum, in other words it verifies the presence or absence of the sensitive datum in the course of the detection of the messages. In particular, the device provided may notify the user of a security breach in real time at the first detection of the presence of the sensitive datum.

In one particular embodiment, the detection method provided furthermore comprises, upon detection of the presence of the sensitive datum in an analyzed message, a step for notifying a user of the device of the detected security breach and of an identifier of the other terminal. The user may then envision, depending on the identifier of the other terminal and/or on the nature of the sensitive datum, a countermeasure action in order to avoid or to reduce the impact of the security breach.

In one particular embodiment, the detection method provided furthermore comprises, upon detection of the presence of the sensitive datum in an analyzed message, at least one countermeasure step which may be chosen from amongst:

a modification of the value of the sensitive datum;

an unpairing of the terminals which have connected to the device for a given duration following the detection of the security breach;

a blocking of connection with the device of any terminal for a given duration following the detection of the security breach;

a maintaining of connection only for the terminal which has connected in the first place to the device after the detection of the security breach; and

a maintaining of connection only for a terminal which has connected to the device for a given duration after the detection of the security breach and which has a MAC address identical to the MAC address of the other terminal.

These steps represent countermeasures allowing the risk of the sensitive datum being obtained by a malicious terminal and the risk of use of the sensitive datum by the malicious terminal (if it has managed to obtain it), for example in order to connect to the detection device according to the invention, to be avoided or at least reduced.

The invention is also aimed at a communications system comprising a detection device according to the invention and at least a first terminal known by the device.

The invention is also aimed at a computer program on a storage medium, this program being able to be implemented in a computer or a device, according to the invention, for detecting a security breach. This program comprises instructions adapted to the implementation of a method for detecting a security breach by the detection device, such as described hereinabove.

This program may use any given programming language, and may take the form of source code, object code, or of code intermediate between source code and object code, such as in a partially compiled form, or in any other desired form.

The invention is also aimed at an information medium or a storage medium readable by a computer, and comprising instructions of the aforementioned computer program.

The information or recording media may be any given entity or device capable of storing the programs. For example, the media may comprise a storage means, such as a ROM, for example a CD ROM or a microelectronic circuit ROM, or else a magnetic recording means, for example a floppy disk or a hard disk, or a flash memory.

On the other hand, the information or recording media may be transmissible media such as an electrical or optical signal, which may be carried via an electrical or optical cable, via radio link, via wireless optical link or by other means.

The program according to the invention may, in particular, be downloaded over a network of the Internet type.

Alternatively, each information or recording medium may be an integrated circuit in which the program is incorporated, the circuit being designed to execute or to be used in the execution of a method for detecting a security breach according to the invention.

### BRIEF DESCRIPTION OF THE DRAWINGS

Other features and advantages of the present invention will become apparent from the description presented hereinbelow, with reference to the appended drawings which illustrate one exemplary embodiment of the invention which is in no way limiting. In the figures:

FIG. 1 illustrates an architecture of a communications network in which a detection method provided may be implemented according to one particular embodiment, the network comprising a detection device provided;

FIG. 2 is a flow diagram representing steps of a detection method provided, implemented according to one particular embodiment;

FIG. 3 is a flow diagram representing steps of a detection method provided, implemented according to one particular embodiment, followed by countermeasure steps against a detected security breach;

FIG. 4 is a flow diagram representing steps of a detection method provided, implemented according to one particular embodiment, followed by countermeasure steps against a detected security breach;

FIG. 5 is a flow diagram representing steps of a detection method provided, implemented according to one particular embodiment, followed by countermeasure steps against a detected security breach;

FIG. 6 is a flow diagram representing steps of a detection method provided, implemented according to one particular embodiment, followed by countermeasure steps against a detected security breach;

FIG. 7 is a flow diagram representing steps of a detection method provided, implemented according to one particular embodiment, followed by countermeasure steps against a detected security breach;

FIG. 8 illustrates a functional architecture of a detection device provided, according to one particular embodiment; and

FIG. 9 shows a hardware architecture of a detection device provided, according to one particular embodiment.

### DETAILED DESCRIPTION OF ILLUSTRATIVE EMBODIMENTS

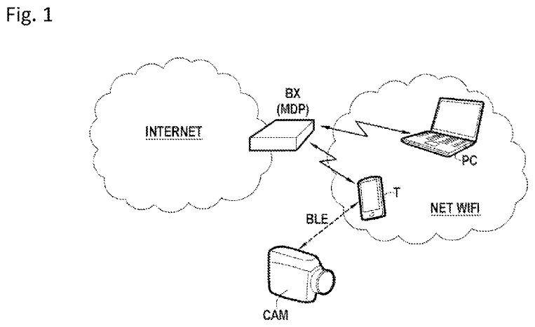

FIG. 1 illustrates an architecture of a communications network comprising a detection device BX according to the invention, according to one particular embodiment. In this embodiment, the detection device BX is a gateway between a local-area network NET and a wide-area network, for example the Internet. In particular, the device BX may be network termination equipment (a ‘box’). The local-area network NET is a WiFi network. Aside from the gateway BX, the network NET comprises a terminal PC and a terminal T with a WiFi connection to the gateway BX.

In the example described here, the terminal PC is a computer able to communicate according to the WiFi standard. The terminal T is a telephone of the smartphone type able to communicate according to the WiFi and Bluetooth standards. The terminals PC and T are connected to the gateway BX using a password MDP for the gateway BX. The password may have been manually input by a user on the terminals PC and T.

Another terminal CAM tries to communicate with the WiFi network NET and to connect to the gateway BX in order to benefit from an access to the Internet. For this purpose, the terminal CAM connects according to the Bluetooth standard to the terminal T and asks it for the password MDP. In the example described here, the terminal CAM is a camera equipped with a communications module which supports the WiFi and Bluetooth standards.

The gateway BX holds the password MDP. This password MDP is a sensitive datum in the sense of the present invention. The gateway BX stores identifiers of the terminals PC and T known by the latter, for example their MAC addresses. These terminals PC and T form first terminals in the sense of the invention

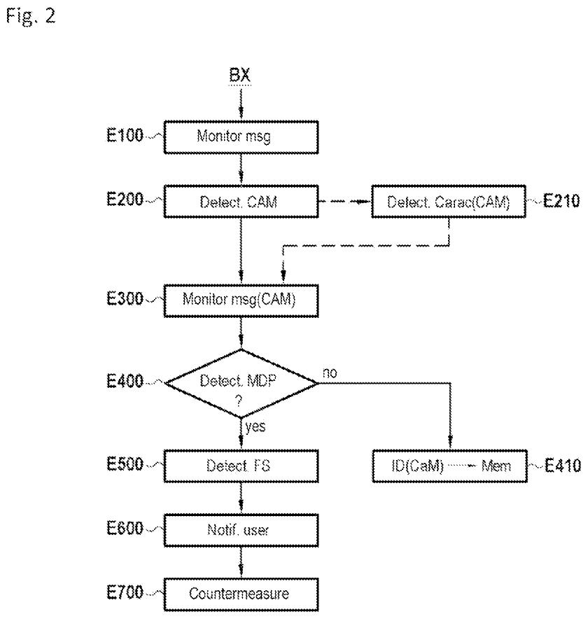

FIG. 2 is a flow diagram representing steps of a method for detecting a security breach, according to the invention, implemented according to one particular embodiment by the detection device BX described with reference to FIG. 1.

During a step E100, the device (gateway) BX monitors the destinations of the messages sent by the terminals T and PC. The device BX does not analyze the contents of these messages but only the identity of their destinations in order to be able to detect a potential message sent to a new terminal, not known by the device BX.

The device BX may monitor messages over communications channels with various technologies, for example WiFi communications channels for the terminal PC and WiFi and Bluetooth communications channels for the terminal T.

During a step E200, the device BX detects that a monitored message is sent by the first terminal T to the terminal CAM. The camera CAM is not paired with the device BX. As no identifier of the terminal CAM is recorded in the memory of the device BX, the device considers that this terminal CAM is a new terminal. If the communication between the first terminal T and the new terminal CAM does not conform to a secure communications protocol, this communication may represent a potential security breach which a malicious terminal may use to obtain the sensitive datum MDP.

In the mode described here, the device BX stores characteristics of the terminals that it knows, for example their MAC addresses, their frequency change algorithms and/or the strength of transmission of their signals. It is assumed that the messages sent by the first terminal T comprise the MAC addresses of their recipients. The device BX relies on the physical MAC address of the terminal CAM in order to determine that it is new. Alternatively, the device BX may rely on characteristics of the terminal CAM such as a frequency change algorithm used by the terminal CAM or a strength of a signal generated by the terminal CAM, as long as the characteristics of the detected terminal CAM are not already stored in memory by the device BX. In this example, the method provided comprises an optional step E210 (shown with a dashed line in FIG. 2) for determining a characteristic of the new terminal CAM.

Upon the detection E200 that the destination of the monitored message is the new terminal CAM, during a step E300, the detection device BX analyzes all the messages sent by the first terminal to the new terminal CAM, for a given duration starting from the detection E200. During this step E300, the device BX analyzes the contents of the messages sent to the new terminal in order to be able to detect a potential cleartext (without encryption or cipher) transmission of the password MDP.

During the analysis step E300, the device BX follows the jumps in frequency of the Bluetooth exchanges between the terminals T and CAM. In the embodiment described here, the device BX uses a frame of the “CONNECT_REQ” type which is sent in cleartext over a channel of the “advertising” type. This frame contains all the information needed to follow a future communication between the terminals T and CAM, such as a size of the communication window (“Window Size”), a channel program (“Channel Map”), a period of time before the first frequency jump (“Window Offset”) and an interval of time between two successive jumps. Other methods of analysis of the contents of the messages according to the prior art may be envisioned depending on the communications technology between the first terminal T and the new terminal CAM, for example Bluetooth, WiFi, Thread, Zigbee, Z-Wave, DECT or DECT ULE.

The analysis step E300 may be implemented for a time sufficient for a user of the detection device BX to pair with the new terminal CAM, for example from 15 to 30 minutes. In particular, the duration of analysis may be determined depending on a characteristic of the new terminal which has been determined during the step E210, for example its manufacturer, its model and/or its type.

During a step E400, the device BX verifies whether the sensitive datum MDP is present in at least one analyzed message. The step E400 may be implemented in the course of the analysis E300. Alternatively, the device BX may store the analyzed contents (E300) of the messages, then detect (E400) or otherwise the presence of the sensitive datum MDP in these messages.

Assuming that, during the step E400, the device BX detects the presence of the sensitive datum MDP in one of the analyzed messages, it then determines, during a step E500, the presence of a security breach FS.

Following the detection E500 of the security breach, the device BX may notify a user of this breach FS during a step E600. In particular, the device BX may reproduce for the user the nature of the sensitive datum MDP and an identifier or a characteristic of the new terminal CAM, such as its MAC address, its manufacturer and/or its model.

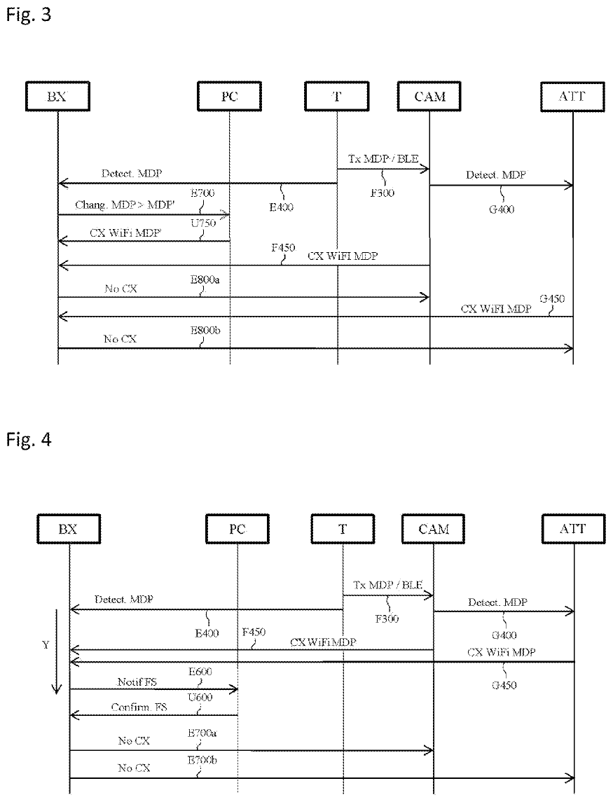

As an option, the device BX may implement, during a step E700, a countermeasure to the security breach detected FS. Examples of countermeasures E700 are described hereinafter with reference to FIGS. 3 to 7.

If, at the end of the period of analysis E300, the device BX does not detect (E400) the presence of a any sensitive data in the analyzed messages, during the step E410, it stores an identifier of the new terminal CAM, for example its physical MAC address, in a memory recording the identifiers of the terminals T and PC already known by the device BX. Thus, the terminal CAM becomes known by the device BX and will no longer be considered as a new terminal, but potentially as a first terminal.

If the first terminal T sends the password MDP in a message in an encrypted manner to the new terminal CAM, when the device BX analysis this message, it determines that it is encrypted and does not then detect any security breach. Indeed, another terminal that intercepts the Bluetooth exchanges between the terminals T and CAM will not be able to recover the password MDP because it will not know how to decrypt the message comprising the password.

In one embodiment, during the step E210, the device BX determines at least one characteristic of the new terminal CAM from amongst its manufacturer, a prefix of its name and a UUID identifier of a service that it supports. The device BX stores a list of manufacturers, of prefixes of names of terminals and/or of UUID identifiers. The device only implements the analysis step E300 if the determined characteristic (E210) of the new terminal CAM is included in the list or excluded from the latter.

For example, the detection device provided may store identifiers of the manufacturers D-Link and Awox (trademarks) who market connected objects. According to another example, the list may comprise the prefix “DCS-” associated with the characteristic org.bluetooth.characteristic.gap.device_name of the connected objects of the D-Link brand. According to another example, the list may comprise the UUID identifier 0xd001 which corresponds to a service used by of the connected objects of the D-Link brand for sending a WiFi connection configuration.

FIG. 3 is a flow diagram representing steps of a detection method provided, implemented according to one particular embodiment, followed by countermeasure steps against a detected security breach FS. The detection method is implemented by the device (gateway) BX described with reference to FIGS. 1 and 2. It is assumed that the device BX has already implemented the steps for monitoring the messages E100 and for detecting E200 a communication involving the new terminal CAM.

During a step F300, the terminal T sends the sensitive datum MDP in cleartext to the new terminal CAM. The device BX then detects, during a step E400 (similar to the step E400 described with reference to FIG. 2), the presence of the sensitive datum in the message sent (F300) and thus detects a security breach during a step E500 similar to the step E500 described with reference to FIG. 2. In FIGS. 3 to 7, the step E500 for detection of the security breach is not shown but it may be considered that it is substantially simultaneous with (or just after) the step E400 for detecting the presence of the sensitive datum MDP.

In parallel, during a step G400, a malicious terminal ATT also detects the presence of the sensitive datum MDP in the message sent (F300). The terminal ATT is a terminal of an attacker which analyzes the contents of the messages between the terminals of the network and tries of recover the sensitive datum MDP.

In this embodiment, upon detection (E500) of the security breach, the device implements a countermeasure step E700 which comprises a modification of the password MDP to a new password MDP′ and sends this new password MDP′ to the terminal PC as it is already connected to the device BX and considered as a trusted terminal.

During a step U750, the terminal PC reconnects to the device BX using the new sensitive data MDP′.

During a step F450, the new terminal CAM tries to connect to device BX using the old password MDP which it has received from the terminal T. During a step E800a, the device BX sends it a refusal of the connection request, because it has not used the right password. Similarly, during a step G450, the attacking terminal ATT sends a request for connection to the device BX using the old password MDP that it has intercepted (G400), but the device BX refuses its request during a step E800b. Thus, the attacking terminal does not succeed in connecting to the gateway BX. The attacking terminal may conclude that the datum MDP is not a valid password for connecting to the device BX, assume that the terminals T and CAM do not hold the password and no longer analyze the messages that they send out.

The device BX may not send the new password MDP′ to the terminal T because it has already disclosed the old password MDP. Alternatively, the device BX may send the new password MDP′ to the terminal T with a configuration request for the latter not to broadcast it or to broadcast it only after an encryption.

FIG. 4 is a flow diagram representing steps of a detection method provided, implemented according to another particular embodiment, followed by countermeasure steps against a detected security breach FS. The detection method is implemented by the device (gateway) BX described with reference to FIGS. 1 and 2. It is assumed here that the device BX has already implemented the monitoring E100 and detection E200 steps.

During a step F300, the terminal T sends the sensitive datum MDP in cleartext to the new terminal CAM. The device BX then detects, during a step E400 (similar to the steps E400 described with reference to FIGS. 2 and 3), the presence of the sensitive datum MDP in the message sent F300. In parallel, the malicious terminal ATT also detects, during a step G400, the presence of the sensitive datum MDP in the message (F300).

The new terminal CAM and the malicious terminal ATT send requests for connection to the device BX using the password MDP during the steps F450 and G450, respectively.

In this embodiment, the device BX activates a timer countdown with a duration Y starting from the detection E400, during which it does not respond to connection requests. Upon expiration of the period Y, during a step E600 (similar to the step E600 described with reference to FIG. 2), the device BX sends a notification to the terminal PC considered to be trustworthy, in order to warn a user of the terminal PC of the security breach FS and of the identifiers of the terminals CAM and TTA which have tried to connect to the device BX.

The user of the terminal PC examines the identifiers of these terminals CAM and ATT and determines whether they are known terminals or likely to be malicious terminals. During a step U600, the trusted terminal PC sends a confirmation of the presence of an attack on the sensitive datum MDP or a command to accept the connections of the terminals CAM and ATT. Assuming that, during the step U600, the terminal PC confirms the presence of an attack attempt, during the countermeasure steps E700a and E700b, the device BX rejects the requests for connection from all the terminals that have requested a connection during the interval Y, i.e. the terminals CAM and ATT.

Alternatively, the terminal PC may specify to the device BX from which terminal (CAM) the device BX should accept the connection request, and for which terminal (ATT) the device BX must refuse the connection request.

According to one variant of the embodiment described in FIG. 4, the device BX sends (E600) a notification on the presence of the security breach FS to the terminal PC as soon as it detects (E400) the presence of the sensitive datum MDP in a message (F300). The user of the terminal PC itself determines the identifiers of the terminals which are trying to connect to the device BX.

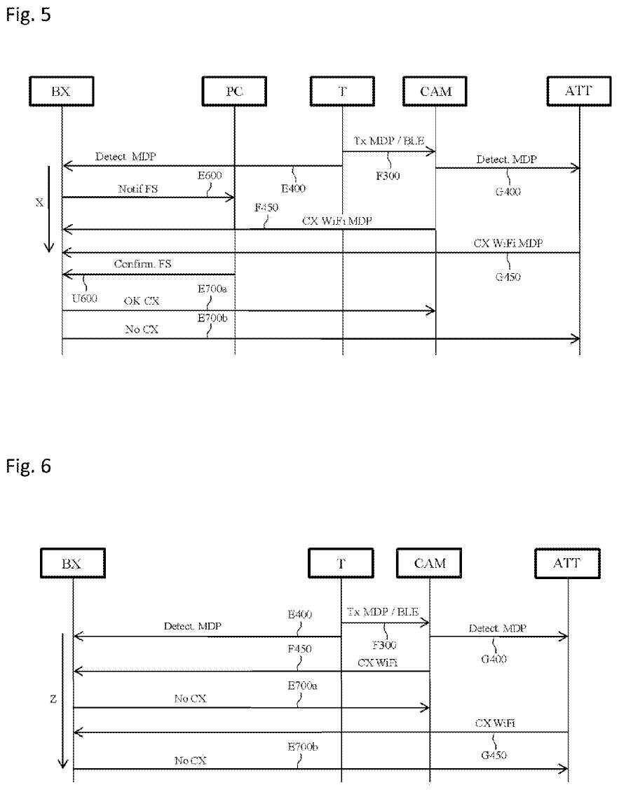

In another embodiment shown in FIG. 5, the device BX activates a countdown clock with a duration X starting from the detection E400. If, at the expiration of this time X, the device BX receives a confirmation (U600) from the terminal PC on the presence of a potential attack, during a countermeasures step E700a, the device BX only accepts the first connection request that it has received during the period X (i.e. the request from the terminal CAM) and refuses, during a countermeasure step E700b, the later requests (i.e. the request from the terminal ATT). Upon receiving the refusal of its connection request, the attacking terminal ATT may considerer that the password MDP is not correct.

In another embodiment shown in FIG. 6, the device BX activates a countdown timer with a duration Z starting from the detection E400 and, during the countermeasure steps E700a and E700b, refuses all the connection requests received during the interval of time Z.

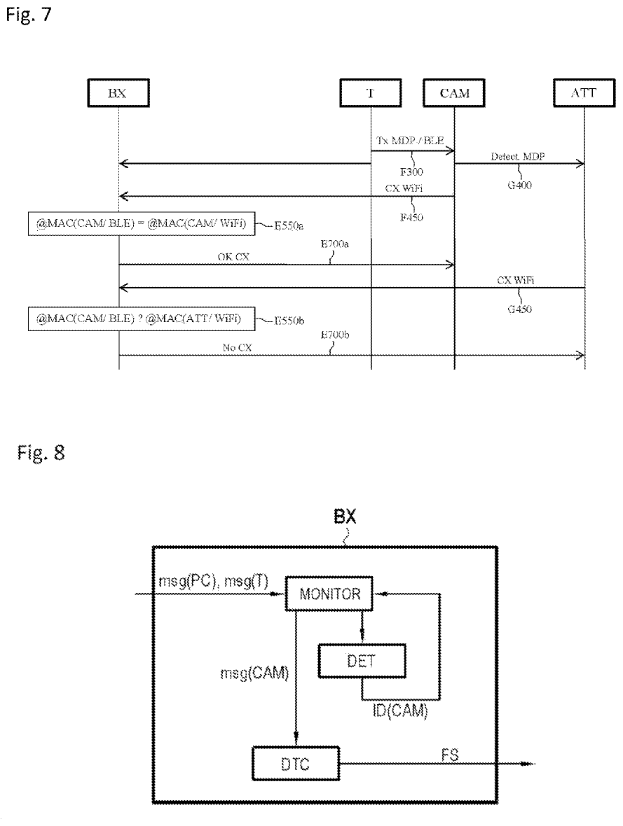

In another embodiment shown in FIG. 7, when the device BX detects (E400) the presence of the sensitive datum MDP in an analyzed message (F300), during this step E400, it stores an identifier of the new terminal CAM, for example its physical MAC address used for sending the message F300 according to the Bluetooth standard.

When the device BX receives a connection request (F450, G450) from a terminal, during a step E550a, E550b, it verifies whether the MAC address used for the connection request corresponds to the MAC address stored in memory during the step E400. Thus, in this example, the device BX verifies, during the step E550a, that the WiFi MAC address of the new terminal CAM is the same as the stored address and then accepts its connection request F450 during a countermeasure step E700a. The device BX verifies, during the step E550b, that the WiFi MAC address of the terminal ATT is different from the stored address and then refuses its connection request G450 during a countermeasure step E700b.

This embodiment is particularly advantageous when the new terminal CAM uses the same physical MAC address for its exchanges according to the Bluetooth protocol and also for the exchanges according to the WiFi protocol. This is possible notably when the new terminal CAM is equipped with the same chip or integrated circuit for the Bluetooth and WiFi communications.

In the embodiments described here, the sensitive datum is a password for connection to the device BX. Sensitive data of other natures may be envisioned, such as personal information of the user of the device BX and/or of the terminal PC.

In the embodiments described here, the device BX only analyzes the messages intended for the terminal CAM because it is a new terminal. Alternatively, the device BX may analyze all the messages irrespective of their destinations. In this case, the device BX does not implement the monitoring E100 and detection E200 steps.

FIG. 8 shows a functional architecture, according to one particular embodiment, of the device BX for detecting a security breach. The device BX holds at least one sensitive datum MDP.

The device BX comprises:

an analysis module SURV configured for analyzing the messages sent by the first terminal T known by the device BX to another terminal CAM; and

a module for detecting breaches DTC configured for detecting a security breach if it detects the presence of the sensitive datum MDP in an analyzed message.

In the embodiments described with reference to FIGS. 1 to 7, the detection device BX furthermore comprises:

a monitoring module SURV configured for monitoring the destinations of the messages sent by the first terminal T; and

a module for detecting new terminals DET configured for detecting that the destination of a message sent is a terminal CAM not known by the device (a new terminal);

said analysis module SURV being configured for only analyzing the messages sent to the new terminal CAM, upon said detection.

In particular and such as shown in FIG. 8, the monitoring and analysis modules may form part of a single module (SURV).

In one embodiment, the device BX furthermore comprises a countermeasure module (not shown in FIG. 8) configured for implementing a step (E700) for countermeasure to the detected security breach FS, for example such as described with reference to FIGS. 3 to 7.

In the embodiments described here, the detection device BX is a gateway. Devices of other natures may be envisioned, such as a server for sensitive data or user equipment or a coverage extender for a communications network.

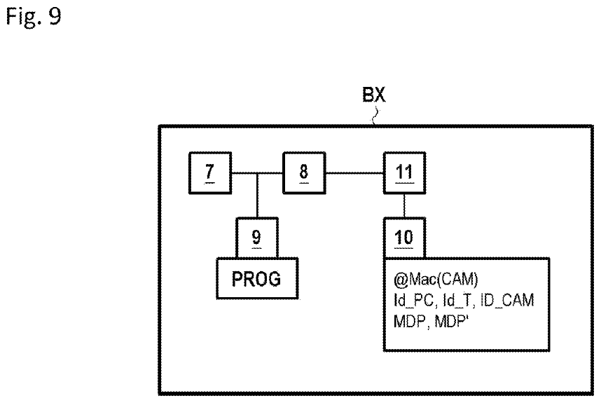

In the embodiments described here, the detection device BX has the hardware architecture of a computer, such as illustrated in FIG. 9.

The architecture of the detection device BX notably comprises a processor 7, a volatile memory 8, a non-volatile memory 9, a non-volatile flash memory 10 in one particular embodiment of the invention, together with communications means 11. Such means are known per se and are not described in more detail here.

The non-volatile memory 9 of the detection device BX according to the invention constitutes a recording medium according to the invention, readable by the processor 7 and on which a computer program PROG according to the invention is recorded.

The memory 10 of the detection device BX allows variables used for the execution of the steps of the detection method according to the invention, such as the MAC address of the camera CAM, identifiers Id_PC, Id_T, Id_CAM of the terminals PC, T and CAM, respectively, and the sensitive datum MDP and MDP′, to be stored.

The computer program PROG here defines functional and software modules, configured for detecting a security breach and potentially for carrying out a countermeasure to the detected breach. These functional modules rely on and/or control the hardware elements 7-11 of the aforementioned detection device BX.

Although the present disclosure has been described with reference to one or more examples, workers skilled in the art will recognize that changes may be made in form and detail without departing from the scope of the disclosure and/or the appended claims.

1. A method for detecting a security breach allowing sensitive data to be recovered, said method being implemented by a device of a network gateway type holding said sensitive data, said sensitive data allowing a terminal of the network to connect to said device, said method comprising:
analyzing messages sent by at least a first terminal of the network managed by the device, referred to as a terminal known by said device, to another terminal; and
a detecting said security breach in response to the device detecting presence of said sensitive data in a said message.

2. The method as claimed in claim 1, furthermore comprising:
monitoring destinations of the messages sent by said at least a first terminal;
detecting that the destination of said message sent is a terminal not known by said device, referred to as a new terminal;
said analyzing the messages being implemented only for the messages sent to said new terminal.

3. The method as claimed in claim 1, in which said analyzing is implemented for a given duration starting from detection of a first message sent by the first terminal to the other terminal.

4. The method as claimed in claim 1, furthermore comprising determining at least one characteristic of said other terminal from amongst:
a manufacturer;
a unique identifier UUID of a service used by said other terminal; and
a prefix of a name of said other terminal;
said analyzing being conditioned by a said characteristic of said other terminal.

5. The method as claimed in claim 2, in which said monitoring comprises eavesdropping on channels of an “advertising” type according to the Bluetooth standard.

6. The method as claimed in claim 2, in which said detecting comprises detecting a characteristic of said new terminal from amongst a Media Access Control (MAC) address, a frequency change algorithm and a strength of transmission by said new terminal.

7. The method as claimed in claim 1, furthermore comprising, upon detection of said security breach, notifying a user of said device of the detected security breach and of an identifier of said other terminal.

8. The method as claimed in claim 1, furthermore comprising, upon detection of said security breach, implementing at least one countermeasure chosen from amongst:
a modification of the value of said sensitive data;
an unpairing of terminals which have connected to said device for a given duration following the detection of the security breach;
a blocking from connection with said device of any terminal for a given duration following the detection of the security breach;
a maintaining of connection only for a terminal which has connected in the first place to said device after the detection of the security breach; and
a maintaining of connection only for a terminal which has connected to said device for a given duration after the detection of the security breach and which has a Media Access Control (MAC) address identical to a MAC address of said other terminal.

9. The method as claimed in claim 2, furthermore comprising, in absence of a detection of said security breach, storing an identifier of said new terminal in a memory comprising identifiers of terminals known by said device.

10. (canceled)

11. A non-transitory computer readable recording medium on which a computer program is recorded, which when executed by a processor of a device of a network gateway type holding sensitive data, implement a method of detecting a security breach allowing the sensitive data to be recovered, said sensitive data allowing a terminal of the network to connect to said device, said method comprising:
analyzing messages sent by at least a first terminal of the network managed by the device, referred to as a terminal known by said device, to another terminal; and
detecting said security breach in response to the device detecting presence of said sensitive data in a said message.

12. A device for detecting a security breach allowing sensitive data to be recovered, said device being of a network gateway type holding said sensitive data, said sensitive data allowing a terminal of the network to connect to said device, the device comprising:
a processor; and
a non-transitory computer readable medium comprising instructions recorded thereon which when executed by the processor configure the device to implement a method comprising:
analyzing the messages sent by at least a first terminal of the network managed by the device, said terminal being known by said device, to another terminal; and
detecting said security breach in response to the device detecting presence of said sensitive data within said message.

13. The device as claimed in claim 12, wherein the instructions further configure the device to implement:
monitoring destinations of the messages sent by said at least a first terminal; and
detecting that s destination of said message sent is a terminal not known by said device, referred to as new terminal;
said analyzing being implemented for only analyzing the messages sent to said new terminal, upon said detection.

14. The device as claimed in claim 12, wherein the device is comprised in network termination equipment, an extender of coverage of a wireless communications network, a server for sensitive data, or user equipment.
